(19) United States
(12) Patent Application Publication
(10) Pub. No.: US 2004/0231526 A1
(43) Pub. Date: Nov. 25, 2004

(54) Method and apparatus for shaping a body of cheese into a plurality of curved bodies of cheese

(75) Inventor: Dennis J. Childress, Monett, MO (US)

Correspondence Address: Brinks Hofer Gilson & Lione, P.O. Box 10395, Chicago, IL, 60610, US

(73) Assignee: Schreiber Foods, Inc.

(21) Appl. No.: 10/443,374

(22) Filed: May 21, 2003

(51) Int. Cl. A47J 37/08

(52) U.S. Cl. 99/386; 99/443 C

(57) ABSTRACT

A method and apparatus shapes a body of cheese into curved bodies of cheese. A preferred dual-wire cutting machine implementing this method generally includes a conveyor assembly; a set of mechanical aims, two vertically strung harp wires, each of which is connected to a mechanical aim; and a drive assembly. The conveyor assembly moves an elongated body of cheese through the dual-wire cutting machine in a horizontal direction. During movement of the body of cheese, the drive assembly moves each mechanical arm in synchronization with the conveyor assembly. Due to the harp wire attached to each mechanical arm, the movement of each mechanical aim creates a cut in the elongated body of cheese, which forms curved bodies of cheese within the elongated body of cheese. Preferably the body of cheese is made of stacked layers of cheese, which may or may not have the layers offset from one another. The preferred method thus produces stacks of curved slices of cheese, which may or may not have slices offset from one another.

### FIELD OF INVENTION

This invention relates to shaping food products. More specifically, this invention relates to shaping elongated bodies of cheese into curved bodies of cheese, and a stack of cheese slices forming a body having at least one curved side.

### BACKGROUND

Traditionally, for those in the commercial food industry to serve food products containing slices of cheese quickly, a food vendor had to precut slices of cheese and stack the slices, placing paper between each slice. Paper between each slice of cheese allows a user to quickly and easily obtain a single slice of cheese without damaging any remaining slices of cheese in the stack. Alternatively, if a food vendor did not have time to precut slices of cheese, a food vendor had to buy precut slices of cheese with paper between each slice.

Using paper between slices of cheese creates problems. One set of problems is that a food vendor has to set aside time to precut slices of cheese and has to approximate the number of cheese slices needed for a given time period. Yet another problem is that precutting slices and placing paper between each slice creates a wasteful byproduct of large amounts of paper, thereby increasing the overall costs for a vendor. In order to solve these problems, Schreiber Foods Inc. developed E-Z PICK SLICES® cheese products described in U.S. Pat. No. 4,046,923.

E-Z PICK SLICES® cheese products include stacks of cheese slices that are offset from each other. The offsetting of the slices within the stack allows a user to quickly and easily obtain a slice of cheese from the stack without damaging the remaining slices by lifting upward on a portion of the slice extending from the stack. To create a stack of E-Z PICK SLICES® cheese, ribbons of cheese are placed on top of each other to form an elongated body of cheese. The ribbons are placed on top of each other such that each ribbon is offset from the ribbon of cheese above and below it on the stack. The elongated body of cheese is then cut into smaller stacks of virtually square slices of cheese. These smaller stacks are either wrapped as is or placed on top of each other, preserving the offsetting of the slices of cheese, so that the end result is a large stack of virtually square slices of cheese. These precut E-Z PICK SLICES® stacks of cheese.

The method of creating an E-Z PICK SLICES® stack of cheese encounters problems when a user desires to use the process used to make E-Z PICK SLICES® cheese products with cheese types that are naturally circular in shape, such as provolone cheese. The commercial food industry desires curved slices of cheese for cheese types that are naturally circular in shape to meet consumer desires. The cheese products are normally large stacks of virtually square, or at least rectangular slices of cheese. The existing process cannot form stacks of curved slices of cheese from elongated bodies of cheese.

Therefore, it is desirable to have a method and a machine for shaping elongated bodies of cheese into curved bodies of cheese, particularly bodies that have offset slices of cheese as in E-Z PICK SLICES® stacks of cheese.

### BRIEF SUMMARY

Accordingly, the present invention relates to a method and apparatus for shaping a body of cheese into a plurality of curved bodies of cheese. In a first aspect, the invention relates to a method of shaping an elongated body of cheese into curved bodies of cheese comprising moving an elongated body of cheese in a horizontal direction, parallel to the direction of elongation, while at least one vertically strung harp wire moves in a direction perpendicular to the direction of movement of the body of cheese, forming a curved cut within the body of cheese.

In a second embodiment, the invention relates to a method of shaping an elongated body of cheese into stacks of curved slices of cheese by cutting a body of cheese into ribbons of cheese, placing the ribbons of cheese on top of each other to form an elongated stack of ribbons, and shaping the stack of ribbons into stacks of curved slices of cheese.

In a third aspect, the invention relates to an apparatus for shaping an elongated body of cheese into curved pieces of cheese, comprising a conveyor assembly for moving the elongated body of cheese in a horizontal direction; at least one mechanical aim with an upper and lower extension moving in a horizontal direction, perpendicular to the horizontal direction of movement of the body of cheese; at least one harp wire strung between an upper and a lower extension of the mechanical arm; and a drive assembly for moving the mechanical arm.

In a fourth aspect, the invention relates to a body of cheese having at least two slices of cheese, each with at least one curved side. The two slices of cheese are stacked on top of each other such that the body of cheese has at least one curved side where the sides of all the slices are in alignment, and the body of cheese has at least one side where every other slice of cheese extends from the body of cheese.

As will become apparent, the present invention solves the problem of shaping an elongated body of cheese into curved bodies of cheese, while providing E-Z PICK SLICES® cheese products.

Advantages of the present invention will become more apparent to those skilled in the art from the following description of the preferred embodiments of the invention, which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a preferred dual-wire cutting machine for shaping an elongated body of cheese into curved bodies of cheese in accordance with the invention;

FIG. 2 is a top view of the central portion of the dual-wire cutting machine of FIG. 1 with some parts left off for sake of clarity;

FIG. 3 is a partial side view of the top central portion of the dual-wire cutting machine of FIG. 1;

FIG. 4 is a perspective view of an elongated body of cheese showing curved cuts making circular bodies of cheese in accordance with one embodiment of the invention;

FIG. 4a is a perspective view of a curved body of cheese taken from the elongated body of cheese with curved cuts shown in FIG. 4;

FIG. 4b is a front view of the curved body of cheese shown in FIG. 4a;

FIG. 4c is a side view of the curved body of cheese shown in FIG. 4a;

FIG. 4d is a rear view of the curved body of cheese shown in FIG. 4a;

FIG. 5 is a perspective view of an elongated body of cheese showing curved cuts making circular bodies of cheese containing an interior precut in accordance with another embodiment of the invention;

FIG. 5a is a perspective view of the curved body of cheese taken from the elongated body of cheese with curved cuts shown in FIG. 5;

FIG. 5b is a front view of the curved body of cheese shown in FIG. 5a;

FIG. 5c is a side view of the curved body of cheese shown in FIG. 5a;

FIG. 5d is a rear view of the curved body of cheese shown in FIG. 5a;

FIG. 5e is a perspective view of the curved body of cheese shown in FIG. 5a, broken apart at the precut;

FIG. 6 is a perspective view of an elongated body of cheese showing curved cuts making longhorn bodies of cheese in accordance with another embodiment of the invention;

FIG. 6a is a perspective view of the curved body of cheese taken from gated body of cheese shown in FIG. 6;

FIG. 6b is a side view of the curved body of cheese shown in FIG. 6a;

FIG. 6c is a front view of the curved body of cheese shown in FIG. 6a;

FIG. 6d is an opposite side view of the curved body of cheese shown showm in FIG. 6a;

FIG. 7 is a perspective view of an elongated body of cheese showing curved cuts making elongated oval-shaped bodies of cheese in accordance with another embodiment of the invention;

FIG. 7a is a perspective view of a curved body of cheese taken from the elongated body of cheese with curved cuts shown in FIG. 7;

FIG. 7b is a side view of the curved body of cheese shown in FIG. 7a;

FIG. 7c is a front view of the curved body of cheese shown in FIG. 7a;

FIG. 7d is an opposite side view of the curved body of cheese shown in FIG. 7a;

FIG. 8 is a perspective view of an elongated body of cheese showing curved cuts making elongated oval-shaped bodies of cheese containing an interior precut in accordance with another embodiment of the invention;

FIG. 8a is a perspective view of the curved body of cheese taken from the elongated body of cheese with curved cuts shown in FIG. 8;

FIG. 8b is a side view of the curved body of cheese shown in FIG. 8a;

FIG. 8c is a front view of the curved body of cheese shown in FIG. 8a;

FIG. 8d is a rear view of the curved body of cheese shown in FIG. 8a;

FIG. 8e is a perspective view of the curved body of cheese shown in FIG. 8a, broken apart at the precut;

FIG. 9 is a diagram of a program hierarchy for a preferred embodiment of a control system showing a main menu, security access menu, product setup menu, and record storage menu;

FIG. 10 is a diagram of a program hierarchy for a preferred embodiment of a control system showing a main menu, product setup menu, and offset menu;

FIG. 11 is a diagram of a program hierarchy for a preferred embodiment of a control system showing a main menu, product setup menu, and miscellaneous parameters menu for a preferred embodiment of the control system; and

FIG. 12 is a diagram of a program hierarchy for a preferred embodiment of a control system showing a security menu.

### DETAILED DESCRIPTION OF THE DRAWINGS AND THE PRESENTLY PREFERRED EMBODIMENTS

“Cheese” as used herein includes 1) conventional cheese (a cheese made by the traditional method of coagulating milk, cutting the coagulated milk to form discrete curds, stirring and heating the curd, draining off the whey, and collecting or pressing the curd), including American-type cheese such as Cheddar, and pasta filata-type cheese such as provolone and mozzarella; 2) UF cheese (a cheese produced by a process in which milk is processed by ultrafiltration and usually diafiltration to remove water and lactose, but leave the whey proteins in the UF retentate); and 3) processed cheese (a class of cheese products that are produced by comminuting, mixing and heating conventional or UF cheese into a homogeneous, plastic mass, with emulsifying agents and optional ingredients, depending on the class of processed cheese produced) including: pasteurized process cheese, pasteurized process cheese food, pasteurized process cheese spread and pasteurized process cheese product. The cheese may be made from other than fresh milk. Preferably the cheese will have a pH of less than 5.6, a moisture content of less than 60% and contain one or more coagulating agents, such as a protease, and most commonly rennet.

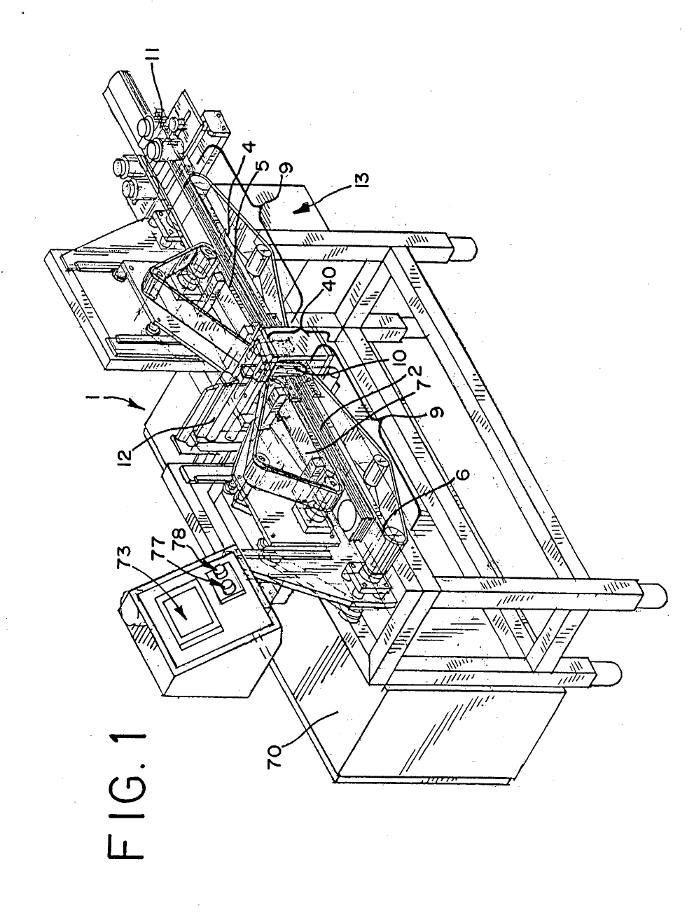

As shown in FIGS. 1, 2, and 3, a dual-wire cutting machine 1 for shaping an elongated body of cheese 2 into curved bodies of cheese generally includes a conveyor assembly 9, at least one mechanical arm 12 with a harp wire 14 strung between an upper extension 50 and a lower extension 52, a drive assembly 15 to move each mechanical aim 12, and a control system, much of which is housed in control box 70.

In general, the conveyor assembly 9 moves the body of cheese 2 into a cutting area 40 of the machine 1 where at least one harp wire shapes the body of cheese 2 into a body of cheese with curved cuts 42. After shaping, the conveyor assembly 9 moves the body of cheese with curved cuts 42 out of the cutting area 40 of the machine 1.

Describing the process in greater detail, the body of cheese 2 is initially fed into the conveyor assembly 9 of the machine 1. The machine 1 is preferably bi-directional in nature such that the body of cheese may be fed into the conveyor assembly 9 to run from left to right or from right to left through the machine 1. In the preferred embodiment, only the set of alignment rollers 11 need be repositioned for a change in machine operating direction. The control system preferably adjusts any other necessary settings in the machine 1 for a change in machine operating direction.

Preferably, the body of cheese 2 is fed from a conveyor assembly of another machine, with which the dual-wire cutting machine 1 forms part of a production assembly. The elongated body of cheese 2 preferably comprises ribbons of cheese stacked on top of one another, but any type of elongated body of cheese 2 could be used. When the body of cheese 2 comprises ribbons of cheese stacked on top of each other, each ribbon may be offset from the ribbon above and below it on the stack so that a portion of each ribbon extends from the normal contour of the body of cheese 2. An elongated body of cheese comprising offset ribbons may be made by the process described in U.S. Pat. No. 4,046,923, which is hereby incorporated by reference. Alternatively, each ribbon may be aligned with the ribbon of cheese above and below it on the stack so that the body of cheese 2 has smooth outer edges.

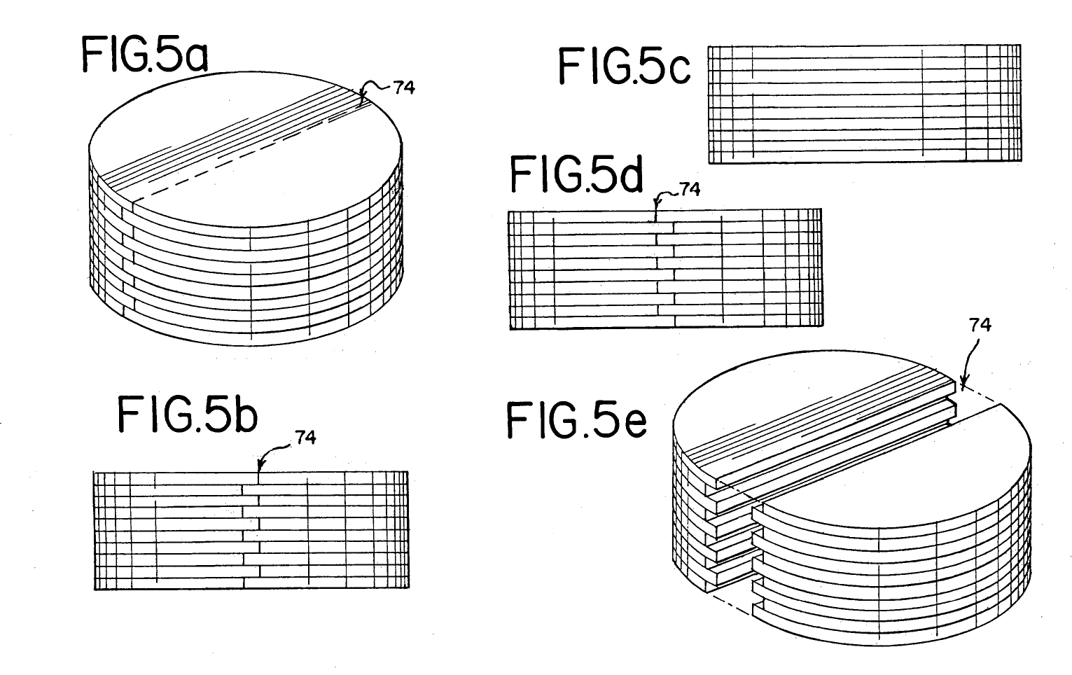

Each ribbon of cheese forming the elongated body of cheese 2 may additionally be precut to form SUB-CUT™ slices of cheese. Any object which creates either a continuous cut partially through each ribbon, or a perforated cut in the ribbon, may create the precut. For example, a pre-cutting roller may create a perforated cut parallel to the sides of the body of cheese and slightly offset in a horizontal direction to the left or right of the center of the ribbon of cheese. Preferably, the precuts are staggered between the ribbons of cheese comprising the elongated body of cheese as shown in FIG. 5 so that the precuts of each ribbon of cheese is offset from the precut on the ribbon of cheese above and below it on the stack. The series of precuts in the elongated body of cheese 2 allows the curved bodies of SUB-CUT™ cheese 2 to be broken at the precut 74 after being shaped by the machine 1. When broken, each curved body of cheese becomes two separate bodies of cheese, each of which contains a curved side and a side where every other slice of cheese on the stack contains a portion extending from the exposed faces created by breaking the body of cheese as shown in FIG. 5E.

As shown in FIG. 1, the conveyor assembly 9 which moves the body of cheese 2 generally includes a lower entry conveyor belt 4, an upper entry conveyor belt 5, a lower outlet conveyor belt 6, an upper outlet conveyor belt 7, a set of support rollers 10, and the set of alignment rollers 11. The body of cheese 2 is fed into the conveyor assembly 9 between the lower entry conveyor belt 4, the upper entry conveyor belt 5, and the alignment rollers 11. Preferably, the alignment rollers 11 adjust the lateral position of the body of cheese between the lower entry conveyor belt 4 and the upper entry conveyor belt 5. The entry conveyor belts place a force on the body of cheese 2 creating a horizontal direction of movement in the body of cheese 2 into the machine 1 and specifically into the cutting area 40. Preferably, the upper entry conveyor belt 5 additionally places a downward force on the body of cheese 2, forcing the body of cheese 2 against the lower entry conveyor belt 4. The downward forces may be generated with pneumatic cylinders (not shown) acting on the structure on which the conveyor belts 5 and 7 are mounted. In general, a manual valve (not shown) operates the pneumatics which also include a filter and a regulator housed in a box 13 located on the side of the machine.

The horizontal forces on the body of cheese 2 move the body of cheese 2 into position in the cutting area 40 of the machine 1, which is surrounded by the set of support rollers 10. Preferably, at least two support rollers are located vertically near the end of the entry conveyor belts and at least two support rollers are located vertically near the beginning of the outlet conveyor belts to prevent the body of cheese from moving laterally within the cutting area 40 while being shaped.

The continuous forward movement of the body of cheese 2 into the cutting area 40 of the machine 1 pushes the body of cheese with curved cuts 42 between the lower outlet conveyor belt 6 and the upper outlet conveyor belt 7. The outlet conveyor belts place an additional horizontal force on the body of cheese 2, which moves the body of cheese with curved cuts 42 away from the cutting area 40 and out of the machine 1 all together. Preferably, the upper outlet conveyor belt 7 additionally places a vertical force on the body of cheese with curved cuts 42, forcing the body of cheese with curved cuts 42 against the lower outlet conveyor belt 6.

The control system adjusts the speed of the entry and outlet conveyor belts. Preferably, the control system is able to independently control the speed of the entry and outlet conveyor belts such that the outlet belts can move slightly faster than the entry conveyor belts. The difference in velocity creates tension in the body of cheese 2 at the cutting area 40, which assists in shaping the body of cheese 2, and separates the body of cheese 2 from the salvage to make packaging of the body of cheese easier.

In a preferred embodiment, the machine 1 contains a first harp wire 14 and a second harp wire 28, but other embodiments of the invention are possible, with one harp wire, or more than two harp wires, or other apparatus for cutting the cheese. Each harp wire is strung vertically and perpendicular to the movement of the body of cheese 2. Within the cutting area 40, the first harp wire 14 and the second harp wire 28 shape the body of cheese 2 during the horizontal movement of the body of cheese 2 by moving in a horizontal direction, perpendicular to the horizontal direction of movement of the body of cheese 2. Preferably, the plane of movement of the harp wire exists between the end of the entry conveyor belts and the beginning of the outlet conveyor belts, to allow the first and the second harp wire 14, 28 to move without obstruction by the conveyor assembly 9.

The harp wires are moved in a horizontal direction, perpendicular to the movement of the body of cheese 2 by a first mechanical aim 12 and a second mechanical arm 26. Each mechanical arm includes an upper extension 50 and a lower extension 52, which the harp wires are strung between. The two extensions allow each mechanical aim to move in a horizontal direction, perpendicular to the movement of the body of cheese 2, with the upper extension 50 passing above the body of cheese 2 and the lower extension 52 passing below the body of cheese 2. Therefore, during movement of each mechanical arm, the harp wire attached to each arm passes directly through the body of cheese 2.

The drive assembly 15 creates movement in the mechanical aims, and therefore the harp wires, generally through the use of a servomotor turning a drive belt. In one embodiment, the first mechanical aim 12 is attached to a first drive belt 16, which is strung between a wheel 20 mounted on a shaft of a first servomotor 18 and a pulley 22. The communication between the first mechanical arm 12 and the first drive belt 16 enables the first drive belt 16 to drive the first mechanical aim 12 in a forward direction, or pull the first mechanical arm 12 in a backwards direction, depending on the direction of rotation of the first servomotor 18.

Specifically, the first servomotor 18 is in communication with the first drive belt 16 at a first servomotor wheel 20. The first servomotor 18 turns the first servomotor wheel 20 in a clockwise or counterclockwise direction, which rotates the first drive belt 16 in a clockwise or counterclockwise direction due to its fixed position between the first servomotor wheel. 20 and the pulley 22. Therefore, through the first servomotor wheel 20, the first servomotor 18 controls the speed and direction of movement of the first drive belt 16, the first mechanical arm 12, and the first harp wire 14.

The control system precisely controls the movement of the drive assembly 15 such that the conveyor assembly 9 and the drive assembly 15 are synchronized to perform the desired cut in the body of cheese 2. Preferably, the elongated body of cheese 2 moves continuously at a uniform rate of speed (which may be adjusted to match other production line speed changes) into the cutting area 40, and the control system controls the servomotor movement and speed so that the harp wires create the desired curved cuts in the body of cheese 2. The control system calculates the proper servomotor movement and speed based on the conveyor assembly 9 speed and the desired shape of the cut.

The conveyor assembly 9 speed is preferably set by user input or through the use of a master line speed signal. The master line speed signal indicates a normalized speed throughout an entire production assembly of which the machine 1 is a part. When the entire system is sped up or slowed down, the master line speed signal into the control system changes, and in response, the control system calculates a new speed for the conveyor assembly 9 and the drive assembly 15 in order to maintain the desired shape.

The control system may be implemented through hardware, software, or any other means known in the art. In one embodiment, the control system generally includes a programmable logic control, such as an Allen Bradley 1756 Control Logic PLC; a servo controller, such as an Allen Bradley 1394 Servo Controller; and a control panel, such as an Allen Bradley Panel View 550 Monochrome Touch Screen.

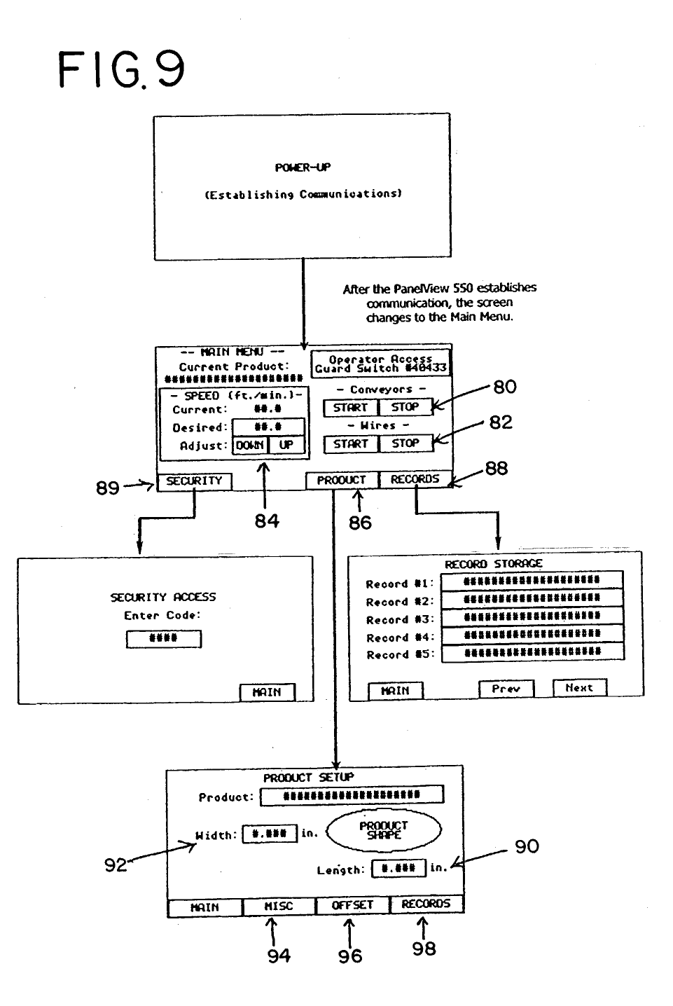

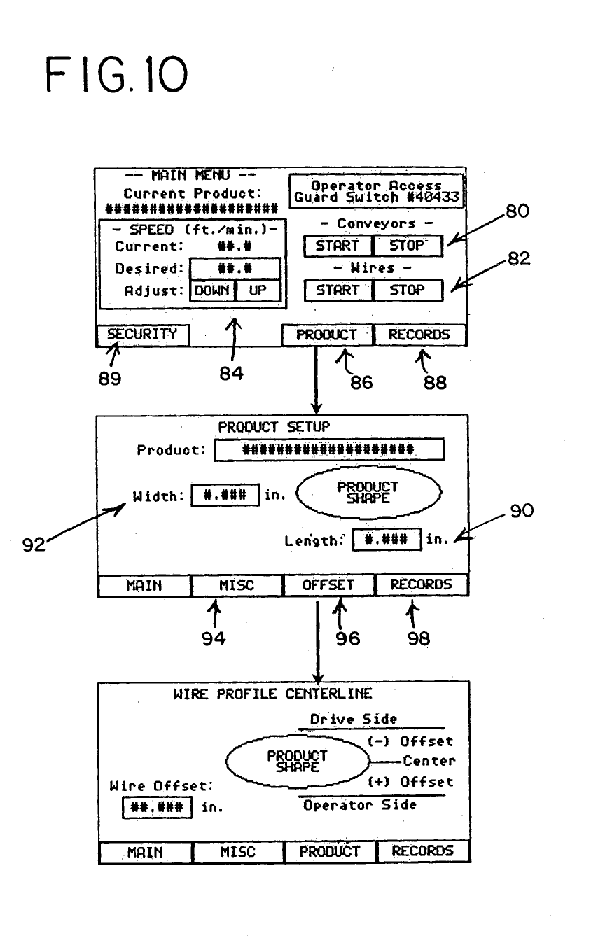

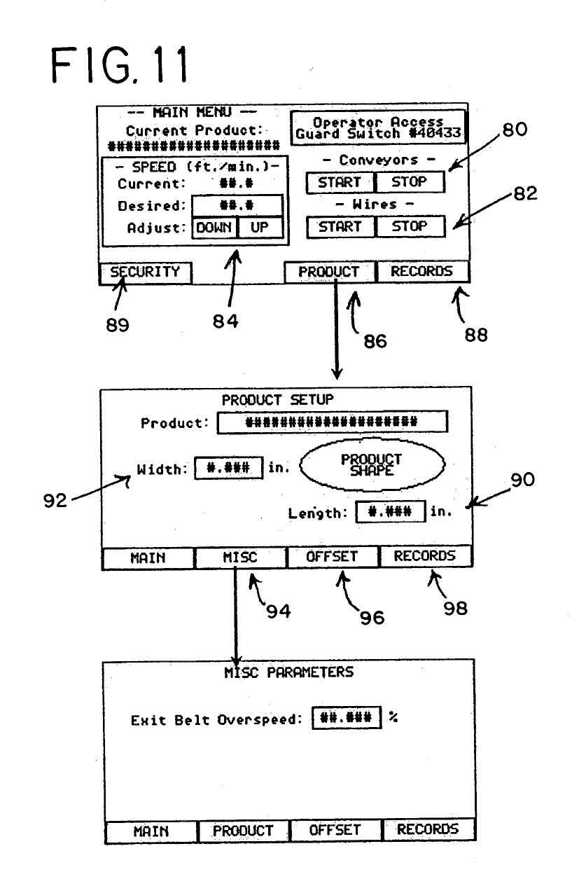

In a preferred embodiment, a user inputs commands through a touch screen 73. The touch screen 73 leads the user through a number of menus that allow inputs into the control system. These menus are shown in FIGS. 9-12. The main menu of the control system shown in FIG. 9 generally includes options to start and stop 80 the conveyor assembly 9, start and stop 82 the drive assembly 15, increase or decrease 84 the speed of the conveyor assembly 9, access a product setup menu 86, access a record storage menu 88, and access a security menu 89. At a lower-level product setup menu show in FIG. 9, a user may input the desired length 90 and width 92 of the product to be cut. Additionally, at the product setup menu, a user may access a miscellaneous parameters menu 94 shown in FIG. 11 where the outlet conveyor belt overspeed percentage can be input; access a wire offset menu 96 shown in FIG. 10 where the centerline of the product shape can be altered to compensate for the lateral position of the body of cheese in the machine 1; and access a record storage menu 98 where various configurations can be stored or activated in the control system 70. A user may also access the record storage menu 88 directly from the main menu.

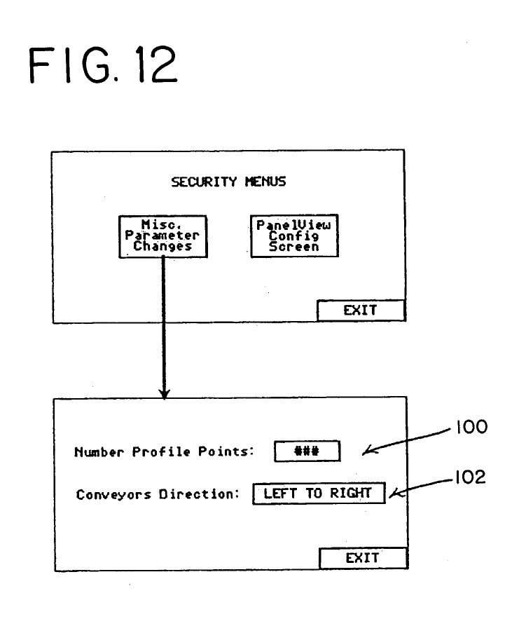

A user may access the security menu shown in FIG. 12 through a security access menu shown in FIG. 9. At the security menu, a user may access a menu to change the hierarchy of the control system or access a miscellaneous parameter changes menu. At the miscellaneous parameter changes menu a user may change the number of profile points within the system or change the direction of the conveyor assembly 9. The number of profile points defines the shape of the cut from the harp wire. More profile points results in a more true curved shape.

Preferably, the control system additionally contains two buttons, as shown in FIG. 1. A first button 77 allows a user to stop the machine 1 in case of an emergency. A second button 78 allows a user to reset the system.

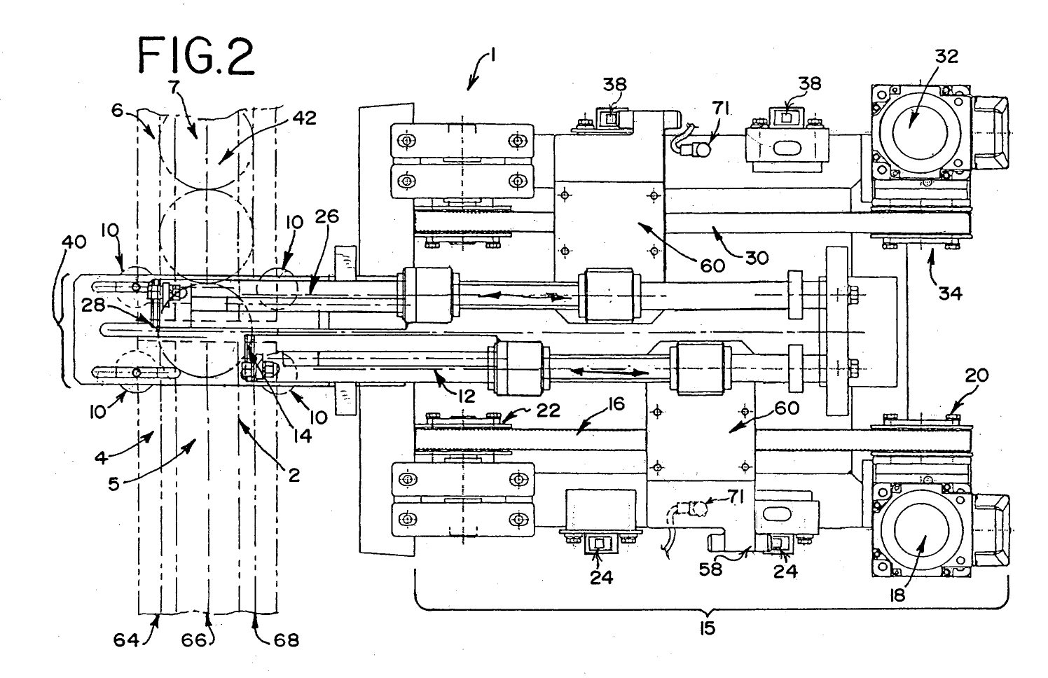

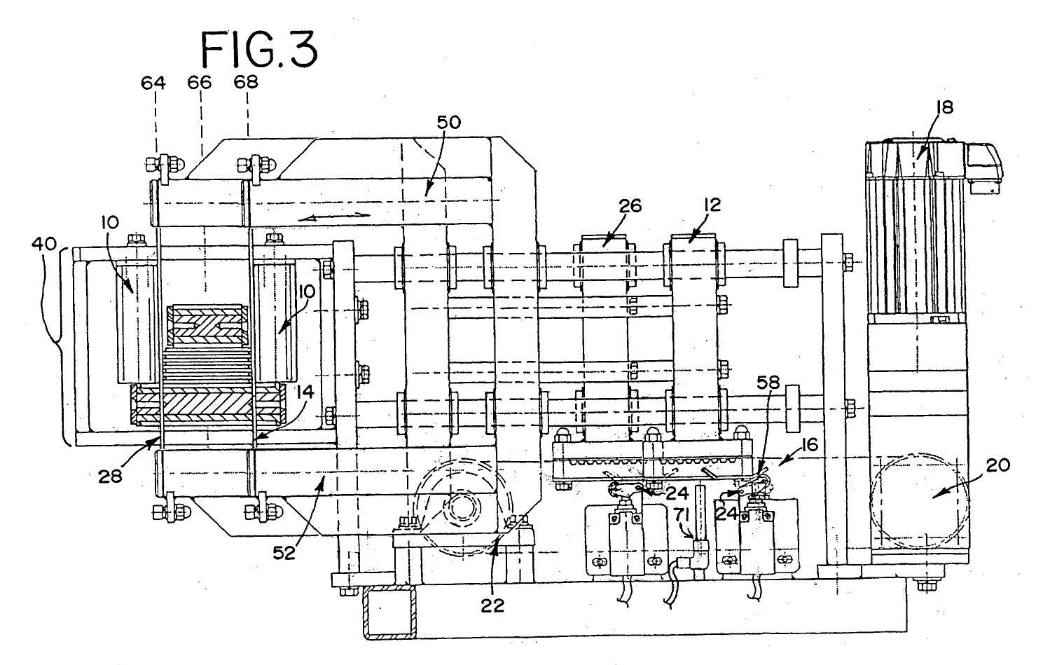

Preferably, the control system includes a first set of over-travel switches 24, best seen in FIGS. 2 and 3. The first set of over-travel switches 24 are placed just beyond the desired full extensions of each direction of movement of the first mechanical arm 12. In a preferred embodiment, each mechanical aim contains a wing 58 extending from a plate 60 attached to the side of the mechanical arm. If a mechanical arm moves beyond the desired full extension of movement, the wing 58 depresses an over-travel switch 24. The depression of the over-travel switch 24 creates a signal within the control system, resulting in the control system 70 stopping the drive assembly 15 to avoid damaging the machine 1.

Preferably, the control system also contains a set of homing proximity switches 71, with one homing switch on each side of the machine 1. The control system uses the homing switches 71 to position the mechanical arms during a home command. In one embodiment, the homing switches 71 are non-contact proximity switches which detect ferrous metal. In this embodiment, during a home command, the control system commands the servomotors to pull each mechanical arm away from the body of cheese 2 until the homing switches 71 detect the leading edge of the plates 60.

The second harp wire 28, second mechanical arm 26, second drive belt 30, second servomotor 32, and second set of over-travel switches 38 are designed having the same connections and communications as the first harp wire 14, first mechanical aim 12, first drive belt 16, first servomotor 18, and first set of over-travel switches 24. The second harp wire 28 is strung between an upper and lower extension on the second mechanical arm 26. The second mechanical arm 26 is securely connected to a second dive belt 30, which is in communication with the second servomotor 32 through a second servomotor wheel 34. Additionally, the second servomotor 32 is electrically connected to the control system to control the velocity and direction of movement of the second servomotor 32. Preferably, the control system contains the second set of over-travel switches 38 to stop the machine 1 in the event the second mechanical arm 26 travels past a full extension in a direction of movement.

During operation, as the body of cheese 2 continually moves in a horizontal direction along the conveyor belts, the first harp wire 14 and the second harp wire 28 move with the first mechanical arm 12 and the second mechanical arm 26 in a horizontal direction, perpendicular to the movement of the body of cheese 2. In one embodiment, the first harp wire 14 repeatedly moves from a first side 64 of the body of cheese 2 to a centerline 66 running down the center of the body of cheese 2, and then back to the first side 64 of the body of cheese 2. It will be appreciated that the wire moves more slowly when it is near the side, and more rapidly when it is near the centerline, to make a rounded cut as the body of cheese 2 moves at a uniform speed.

More specifically, as the body of cheese 2 moves in a horizontal direction, the first harp wire 14 moves from the first side 64 of the body of cheese 2 to the centerline 66 due to the first servomotor 18 turning the first servomotor wheel 20 in a clockwise direction. The clockwise rotation of the first servomotor wheel 20 rotates the first drive belt 16 in a clockwise direction, pulling the first mechanical arm 12 and the first harp wire 14 from the first side 64 of the body of cheese 2 toward the centerline 66.

When the first harp wire 14 reaches the centerline 66, the control system signals the first servomotor to change the direction of rotation of the first servomotor wheel 20. In response, the first servomotor 18 rotates the first servomotor wheel counterclockwise causing the first drive belt 16 to rotate around the first servomotor wheel 20 in a counterclockwise direction. The counterclockwise movement of the first drive belt 16 pushes the first mechanical arm 12 and the first harp wire 14 from the centerline 66 to the first side of the body of cheese 2.

When the first mechanical aim 12 reaches the first side 64 of the body of cheese 2, the control system sends a signal to the first servomotor 18 to change the direction of rotation of the first servomotor wheel 20. Due to this signal, the first servomotor 18 begins rotating the first servomotor wheel 20 in a clockwise direction and the process is repeated.

Simultaneous with the movement of the first harp wire 14 away from the first side 64 of the body of cheese 2 to the centerline 66, the second harp wire 28 moves with the same speed as the first harp wire 14 from a second side 68 of the body of cheese 2 opposite of the centerline 66 from the first side, to the centerline 66. Then, as the first harp wire 14 moves from the centerline 66 to the first side 64, the second harp wire 28 moves with the same speed as the first harp wire 14 from the centerline 66 to the second side 68. The second harp wire 28, second mechanical aim 26, second drive belt 30, second servomotor 32, second servomotor wheel 34, and control system operate together in the same manner as the first harp wire 14, first mechanical arm 12, first drive belt 16, first servomotor 18, first servomotor wheel 20, and control system described above.

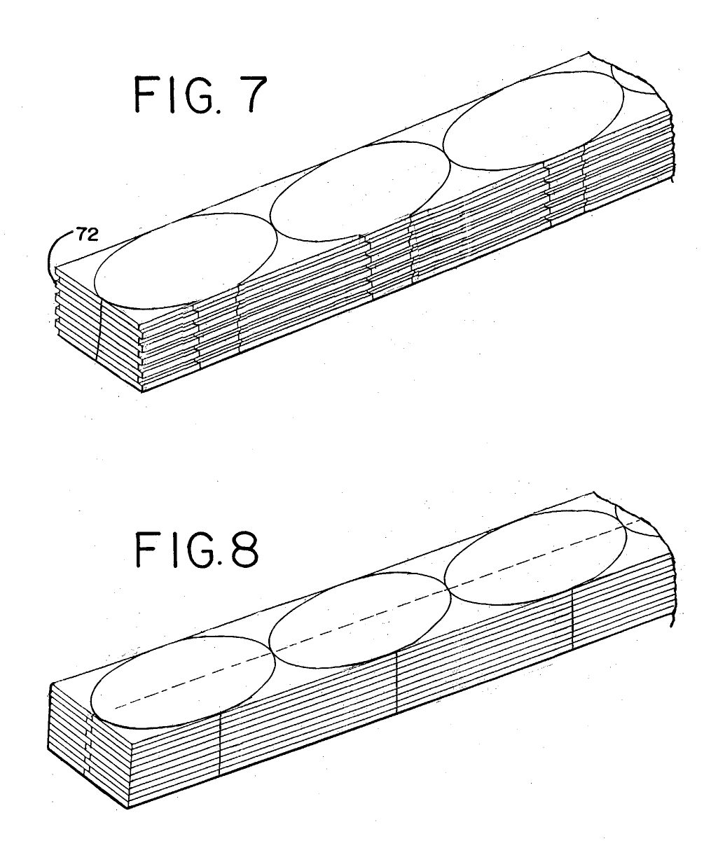

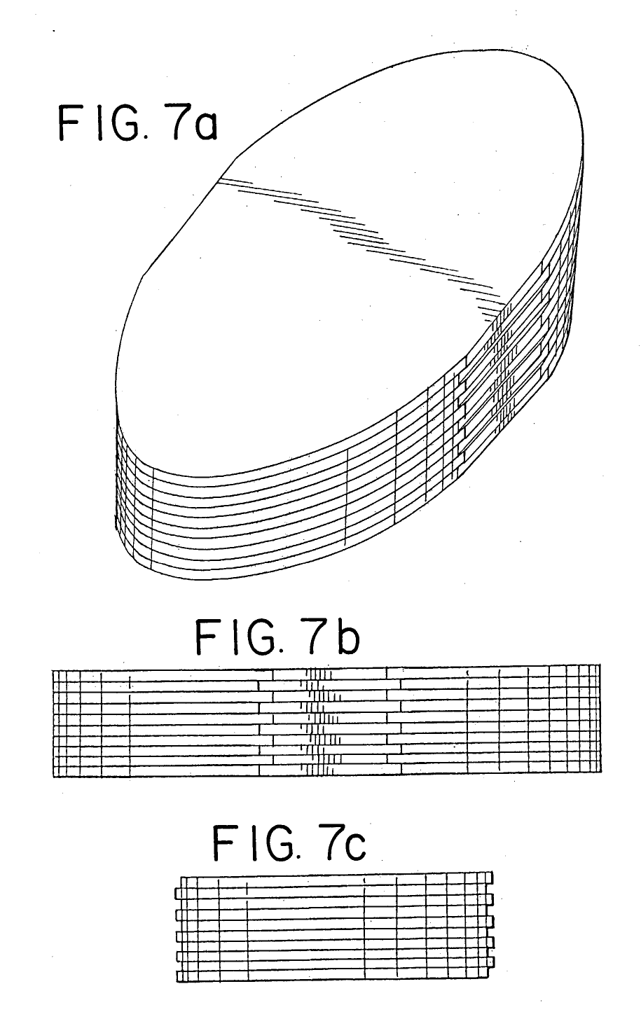

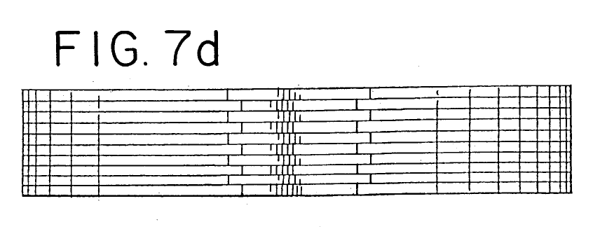

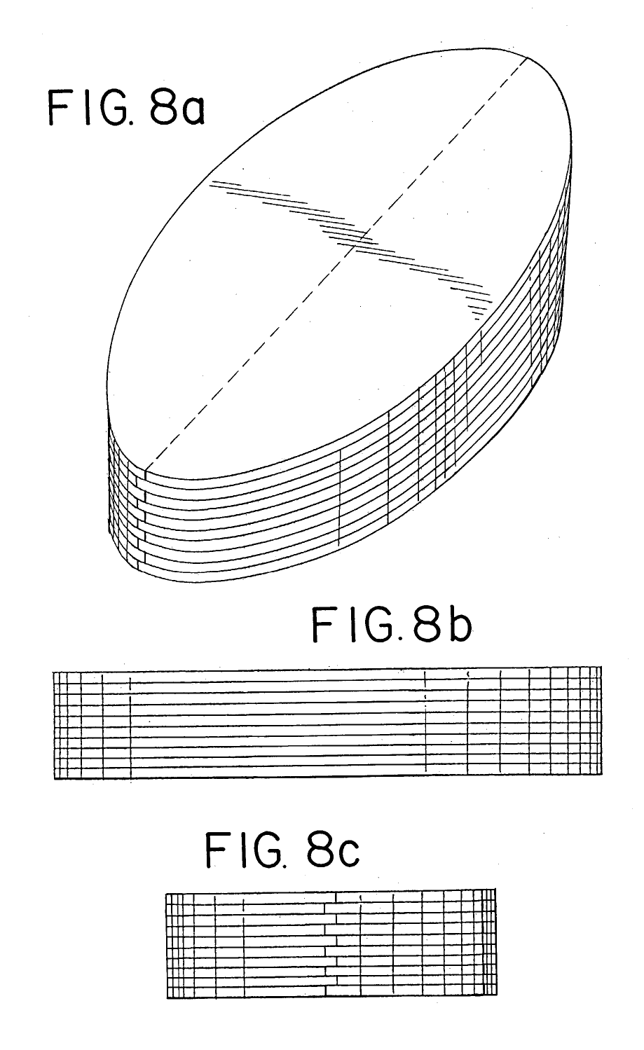

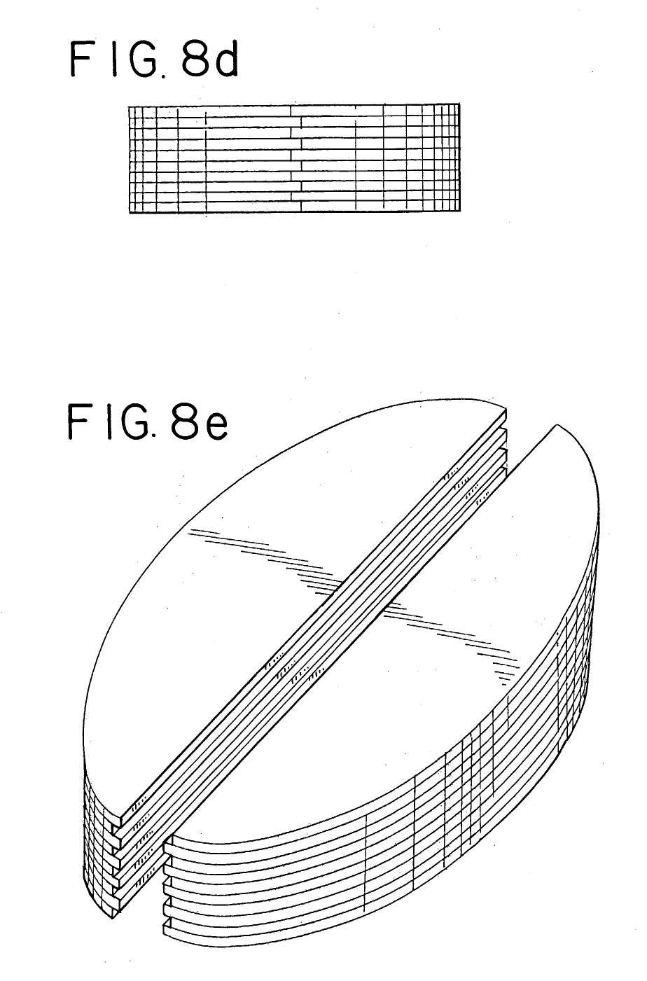

As the first and second harp wires 14, 28 pass through the elongated body of cheese 2, each wire creates a set of multiple quarter-circle cuts which collectively create whole circle cuts in the body of cheese 42 as shown in FIGS. 2, 4, and 5, or a set of multiple quarter-elliptical cuts which collectively create whole elliptical cuts in the body of cheese as shown in FIGS. 7 and 8.

In another embodiment, the first harp wire 14 continually moves from the first side 64 of the body of cheese 2 to the second side 68 of the body of cheese 2, and then back to the first side 64 of the body of cheese 2. At the same time, the second harp wire 28 continually moves from the second side 68 of the body of cheese 2 to the first side 64 of the body of cheese 2, and then back to the second side 68. Each wire creates a sinusoidal cut in the body of cheese 2, which passes through the centerline 66 at the same point, resulting in multiple circular cuts in the body of cheese 42.

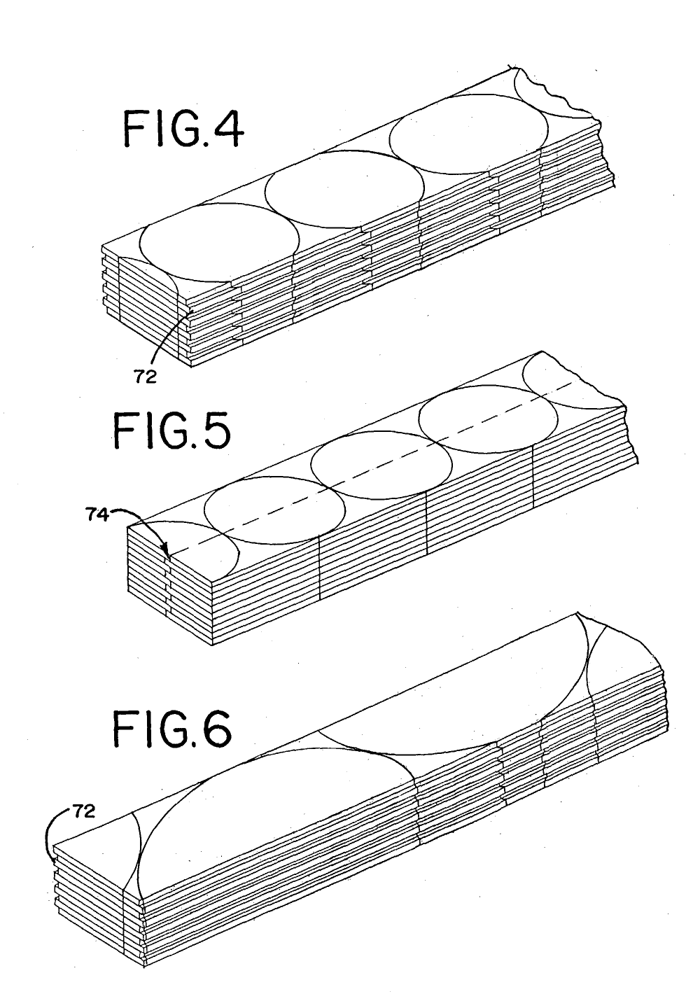

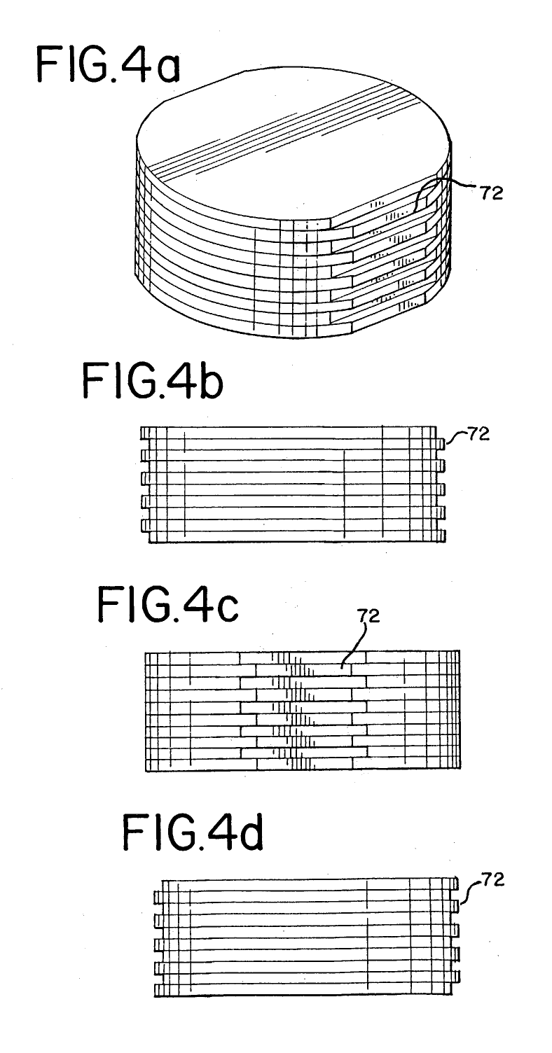

Once removed from the body of cheese with multiple curved cuts 42 the curved body of cheese taken from the elongated body of cheese shown in FIG. 4 appears as shown in FIGS. 4a through 4d and the curved body of cheese taken from the elongated body of cheese shown in FIG. 7 appears as shown in FIGS. 7a through 7d. In both embodiments, the body of cheese is an E-Z PICK SLICES® stack of cheese, and each slice of cheese, though having a curved shape, is offset so that it has an edge 72 extending from the body of cheese 2. If desired, these stacks can later be cut vertically through a diameter of the circle and perpendicular to the direction of movement to produce E-Z PICK SLICES® half circle stacks of cheese.

When removed from the body of cheese containing a precut, a SUB-CUT™ curved body of cheese taken from the elongated body of cheese shown in FIG. 5 appears as shown in FIGS. 5a through 5d and a SUB-CUT™ curved body of cheese taken from the elongated body of cheese shown in FIG. 8 appears as shown in FIGS. 8a through 8d. The curved body of cheese can be broken in half at the precut 74 as shown in FIGS. 5E and 8E. When broken, the curved body of cheese becomes two bodies of cheese 76, each of which contains a curved side and a side where every other slice has a portion extending from the normal contour of the stack.

In both of the above-described embodiments, the first harp wire 14 and the second harp wire 28 do not have to move simultaneously, but to the extent the plane of movement of the first harp wire 14 and the plane of movement of the second harp wire 28 are spaced from one another, the timing of the harp wires must be adjusted so that their respective cuts line up when made in the moving body of cheese 2.

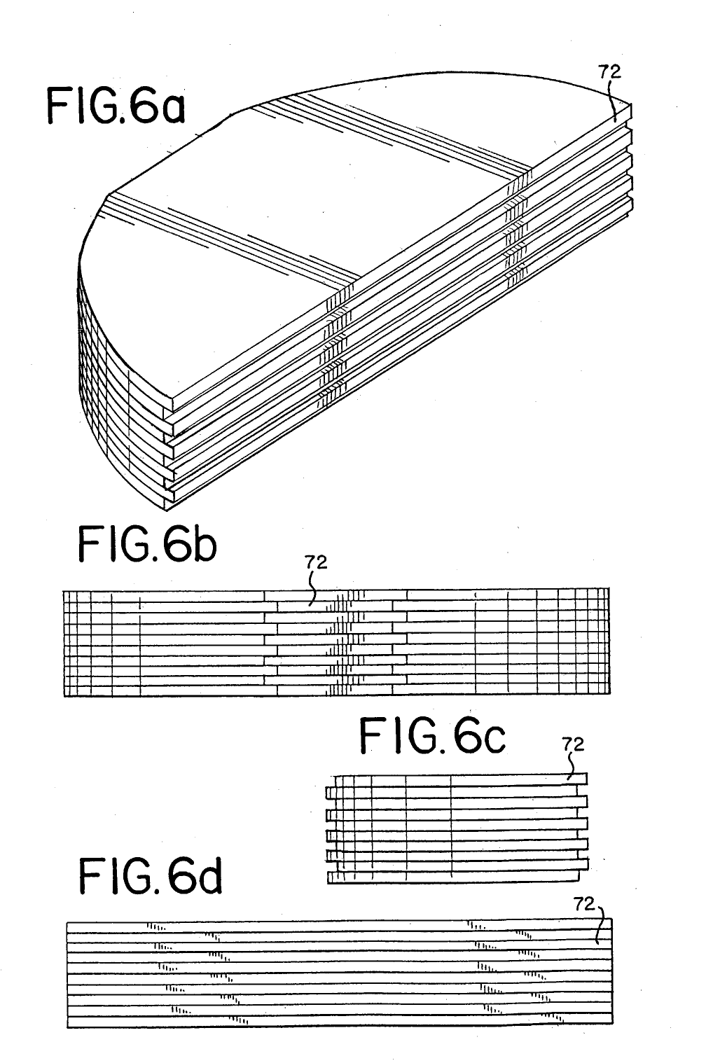

In yet another embodiment, the first harp wire 14 moves from the first side 64 of the body of cheese 2 to the second side 68 of the body of cheese 2, and then back to the first side 64 of the body of cheese 2. The second harp wire 28 then moves from the second side 68 of the body of cheese 2 to the first side 64, and then back to the second side 68. This motion of the first harp wire 14 and the second harp wire 28 creates elongated half-circle shapes, known as longhorn cuts, as shown in FIG. 6. Once removed from the body of cheese with curved cuts, the elongated half-circle body of cheese appears as shown in FIGS. 6A through 6D.

The described embodiments provide a method to shape elongated bodies of cheese into curved bodies, while preferably providing E-Z PICK SLICES® cheese products. This method allows a manufacturer to use the same process to produce elongated bodies of cheese to make slices of naturally square types of cheese and naturally curved types of cheese. More importantly, this method provides the ability to make E-Z PICK SLICES® bodies of cheese with curved shapes, allowing food vendors to buy precut stacks of curved slices of cheese where slices can be easily removed from the stack without damaging remaining slices of cheese and without creating a wasteful byproduct of paper.

It should be appreciated that the apparatus, method and products of the present invention are capable of being represented in the form of a variety of embodiments, only a few of which have been illustrated and described above. The invention may be embodied in other forms without departing from its spirit or essential characteristics. For example, a water jet could be used instead of a harp wire, or a rounded ultrasonic cutting horn could be used to cut circular stacks out of a continuous stack of off-set ribbons of cheese, the diameter of the horn being slightly larger than the width of the stack, thereby providing nearly round E-Z PICK SLICES® cheese products. Thus, the scope of the invention is defined by the appended claims, and all methods, devices, and products that come within the meaning of the claims, either literally or by equivalence, are intended to be embraced therein.

1. A method of shaping an elongated body of cheese into curved bodies of cheese comprising:
a) moving said elongated body of cheese in a generally horizontal direction parallel to the direction of elongation of said body; and
b) moving at least one vertically strung hail wire in a direction perpendicular to the direction of said movement of said body of cheese during horizontal movement of said body of cheese, thereby forming a curved cut within said body of cheese.

2. The method of claim 1 wherein said elongated body of cheese moves continuously.

3. The method of claim 2 wherein said elongated body of cheese moves at a uniform rate of speed.

4. The method of claim 1 wherein said elongated body of cheese comprises stacked layers of cheese.

5. The method of claim 4 wherein said stacked layers of cheese are placed offcenter from one another in a direction perpendicular to the direction of elongation.

6. The method of claim 4 wherein said stacked layers of cheese are precut in an offset manner in the interior of said elongated body of cheese.

7. The method of claim 1 wherein said curved cut is a circular-shaped cut.

8. The method of claim 1 wherein said curved cut is a longhorn-shaped cut.

9. The method of claim 1 wherein the step of moving the at least one harp wire comprises:
a) moving a first harp wire located on a first side of said body of cheese in a plane from said first side to a centerline of said body, and then back to said first side, cutting a first set of quarter circle cuts in said body of cheese; and
b) moving a second harp wire located on a second side of said body opposite of said centerline from said first side, in a second plane from said second side to said centerline, and then back to said second side, cutting a second set of quarter circle cuts in said body of cheese, wherein said first and second sets of quarter circle cuts connect to form two half circle cuts.

10. The method of claim 1 wherein the step of moving the at least one harp wire comprises:
a) moving a first harp wire located on a first side of said body of cheese in a plane from said first side to a second side of said body opposite of said first side, then back from said second side to said first side, the movement of said first harp wire creating a first set of sinusoidal cuts in said body of cheese; and
b) moving said second harp wire in a second plane, parallel to said first plane, from said second side of said body towards said first side, then back from said first side to said second side, creating a second set of sinusoidal cuts in said body of cheese, wherein said first and second sets of sinusoidal cuts form two circle cuts.

11. The method of claim 10 wherein said second harp wire is always moving in a direction opposite to the direction of movement of said first harp wire.

12. The method of claim 1 wherein the step of moving the at least one harp wire comprises moving a first harp wire located on a first side of said body of cheese from said first side to a second side of said body opposite of said first side, then back from said second side to said first side.

13. The method of claim 12 wherein said movement of said first harp wire cuts an elongated half-oval in said body of cheese.

14. The method of claim 12 wherein said movement of said first harp wire cuts a half-circle in said body of cheese.

15. An apparatus for shaping an elongated body of cheese into curved pieces of cheese comprising:
a) a conveyor assembly for moving said elongated body of cheese in a horizontal direction;
b) at least one mechanical aim with a range of movement horizontal and perpendicular to said horizontal movement of said body of cheese, wherein said arm has an upper and a lower extension in a plane that is vertical and perpendicular to said horizontal direction of movement of said body of cheese, wherein the upper extension of said mechanical arm may pass over said body of cheese and the lower extension of said mechanical arm may pass below said body of cheese;
c) at least one harp wire, strung vertically between said upper and said lower extensions of said mechanical aim; and
d) a drive assembly moving said at least one mechanical arm.

16. The apparatus of claim 15 wherein said at least one mechanical aim comprises a first mechanical aim and a second mechanical aim, each having an upper and a lower extension.

17. The apparatus of claim 16 wherein said at least one harp wire comprises a first harp wire, strung vertically between said upper and said lower extensions of said first mechanical arm, and a second harp wire, strung vertically between said upper and said lower extensions of said second mechanical arm.

18. The apparatus of claim 15 wherein said conveyor assembly comprises:
a) at least one entry belt for moving said body of cheese into a cutting area;
b) at least one outlet belt for moving said body of cheese away from said cutting area;
c) a plurality of alignment rollers aligning said body of cheese on said at least one entry belt; and
d) a plurality of support rollers holding said body of cheese from lateral movement during cutting.

19. The apparatus of claim 18 wherein said at least one entry belt comprises:
a) a lower entry belt for forcing said body of cheese in said horizontal direction of movement; and
b) an upper entry belt for forcing said body of cheese in said horizontal direction of movement and placing a vertical force downward on said body of cheese against said lower entry belt.

20. The apparatus of claim 18 wherein said at least one outlet belt comprises:
a) a lower outlet belt for forcing said body of cheese in said horizontal direction of movement; and
b) an upper outlet belt for forcing said body of cheese in said horizontal direction of movement and placing a vertical force downward on said body of cheese against said lower outlet belt.

21. The apparatus of claim 15 wherein said drive assembly comprises:
a) a first servomotor having a shaft; and
b) a first drive belt connected to said first servomotor and said mechanical arm such that rotation of the servomotor shaft of said first servomotor creates movement in said first drive belt and said mechanical arm.

22. The apparatus of claim 21 wherein said drive assembly further comprises:
a) a second servomotor having a shaft; and
b) a second drive belt connected to said second servomotor and a second mechanical arm such that rotation of the servomotor shaft of said second servomotor creates movement in said second drive belt and said second mechanical arm.

23. The apparatus of claim 22 further comprising a first set of over-travel switches positioned with respect to said first mechanical arm such that said first set of over-travel switches detects an overextension of said first mechanical aim and signals said first servomotor to stop the movement of said first drive belt.

24. The apparatus of claim 23 further comprising a second set of over-travel switches positioned with respect to said second mechanical aim such that said second set of over-travel switches detects an overextension of said second mechanical aim and signals said second servomotor to stop the movement of said second drive belt.

25. The apparatus of claim 15 further comprising a control system controlling velocity and positioning of said drive assembly and controlling said velocity of said conveyor assembly.

26. The apparatus of claim 25 further comprising at least one homing proximity switch to assist said control system in positioning said at least one mechanical arm during a home command.

27. The apparatus of claim 15 wherein said body of cheese may move from left to right or from right to left along said conveyor assembly.

28. An apparatus for shaping an elongated body of cheese into curved bodies of cheese comprising:
a) a conveyor assembly for moving said elongated body of cheese in a horizontal direction;
b) a series of alignment rollers positioning said elongated body of cheese on said conveyor assembly;
c) a series of support rollers holding said body of cheese from lateral movement during cutting;
d) at least two mechanical arms with a range of movement horizontal and perpendicular to said horizontal movement of said body of cheese, each aim having an upper and a lower extension in a plane that is vertical and perpendicular to said horizontal direction of movement of said body of cheese, wherein said upper extension of each arm may pass over said body of cheese and said lower extension of each arm may pass underneath said body of cheese;
d) at least two harp wires, one of each being strung vertically between said upper and lower extensions of said mechanical arms;
e) at least two servomotors;
f) at least two drive belts, wherein a first drive belt is connected to a first servomotor and a first mechanical arm such that rotation of said first servomotor creates movement in said first drive belt and said first mechanical aim, and a second drive belt is connected to a second servomotor and a second mechanical arm such that rotation of said second servomotor creates movement in said second drive belt and said second mechanical arm; and
g) at least two sets of ovel-travel switches wherein a first set of over-travel switches is positioned with respect to said first mechanical arm such that said first set of over-travel switches detects an overextension of said first mechanical aim and signals said first servomotor to stop the movement of said first belt, and a second set of over-travel switches is positioned with respect to said second mechanical aim such that said second set of over-travel switches detects an overextension of said second mechanical arm and signals said second servomotor to stop the movement of said second belt.

29. The apparatus of claim 28 further comprising a control system controlling the velocity and direction of rotation of said first and second servomotors, and controlling the velocity of said conveyor assembly.

30. A method of shaping a body of cheese into stacks of curved slices of cheese comprising:
a) cutting a body of cheese into ribbons of cheese;
b) placing said ribbons of cheese on top of each other to form an elongated stack of ribbons of cheese; and
c) shaping said stack of ribbons of cheese into stacks of curved slices of cheese.

31. The method of claim 30 wherein placing said ribbons of cheese on top of each other comprises placing said ribbons of cheese on top of each other in an offset manner to form a stack of offset ribbons of cheese.

32. The method of claim 30 wherein shaping said stack of ribbons of cheese into stacks of curved slices of cheese comprises moving at least one cutting device through said stack of ribbons of cheese, thereby forming curved cuts within said stack of ribbons, which create a separate stacks of curved slices of cheese.

33. The method of claim 32 wherein moving at least one cutting device through said stack of ribbons of cheese comprises moving said stack of ribbons of cheese in a horizontal direction and moving said cutting device in a horizontal direction, perpendicular to the movement of said stack of ribbons of cheese.

34. A body of cheese having at least two slices of cheese each with at least one curved side, said at least two slices stacked on top of each other such that said body of cheese has at least one curved side where the sides of all the slices in the stack are in alignment, and said body of cheese has at least one side where every other slice of cheese extends from said body of cheese.

35. The body of cheese of claim 34 wherein said body of cheese is in a circular shape.

36. The body of cheese of claim 34 wherein said body of cheese is in a longhorn shape.

37. The body of cheese of claim 34 wherein said body of cheese is in a half-circle shape.

38. The body of cheese of claim 34 wherein said body contains at least eight slices of cheese.

39. The body of cheese of claim 34 wherein the body of cheese has two sides where every other slice of cheese extends from said body of cheese, the slices extend on the two sides in an alternating manner.
